(19) United States
(12) Patent Application Publication
(10) Pub. No.: US 2025/0332636 A1
(43) Pub. Date: Oct. 30, 2025

(54) Filter For The Filtration Of A Liquid Metal

(71) Applicant: Les Produits Industriels De Haute Temperature Pyrotek Inc., Sherbrooke (CA)

(72) Inventors: Jay Fritzke, North East, PA (US); Michael Bouchard, Sherbrooke (CA); Andrew Carlson, Spokane, WA (US); Spencer Bishop, Spokane, WA (US)

(73) Assignee: Les Produits Industriels De Haute Temperature Pyrotek Inc., Sherbrooke (CA)

(21) Appl. No.: 19/259,684

(22) Filed: Jul. 3, 2025

Related U.S. Application Data
(63) Continuation of application No. 16/535,639, filed on Aug. 8, 2019.
(60) Provisional application No. 62/717,120, filed on Aug. 10, 2018.

(51) Int. Cl. B22D 43/00; B01D 39/08

(52) U.S. Cl. CPC B22D 43/004; B01D 39/08; B01D 2239/0457; B01D 2239/0464; B01D 2239/1275

(57) ABSTRACT

A filter for filtering a liquid metal and to be received in a mold housing defined by internal side and face walls. The filter has a top wall and side walls extending downwardly from the top wall, the side walls being joined together at respective corners. The side walls extend downwardly towards distal end portions. The corners of the filter have a stiffness or rigidity that is higher that the remainder of the filter for increasing the strength of the overall filter and for helping the filter to maintain its shape and integrity throughout casting. The shape of the side walls allows an easy and consistent placement of the filter in the mold housing and ensures that the filter is maintained in place.

### FIELD

The invention relates to a filter for the filtering of a liquid metal. The filter is to be received in a mold cavity where the side walls of the filter at least partially contact the side walls of the mold cavity. At least parts of end portions of the side walls abut the face walls of the mold cavity. The filter has a top wall or filtering wall and the filtering process is carried out in any kind of casting processes with the filter, and more particularly, in a gravity casting process or in a low-pressure casting process.

### BACKGROUND

Filters are used during casting processes to prevent some debris or impurities to enter the cavities. These filters, which are subjected to a pressure exerted by a flow of liquid metal or alloy passing therethrough, may be metallic filters (i.e. grids of metal threads), non-metallic filters (i.e. fabrics of heat resistant fibers eventually provided with a protective coating and/or impregnated with a rigidifying substrate), or ceramic foam filters. Each filter has a geometric configuration for matching with a corresponding geometric configuration defined by the mold housing in which the filter is to be received.

Occasionally the pressure exerted by the flow of liquid metal or alloy passing through the filter may deform the same to allow some debris or impurities to enter the cavity intended to form the molded article. Worst, it may happen that the flow of liquid metal drives the filter within the cavity of the mold. In both situations, resulting articles are rejected by the quality control to thereby reduce the efficiency of the casting process and increase the operation costs.

Normally, debris or impurities are retained by the filter and, after the liquid metal or alloy has solidified within the mold, they remained trapped within a chunk (i.e., protrusion) of metal that will be detached from the molded article by any appropriate means very well known to persons skilled in art; and re-melted for metal recovery.

It is often difficult to efficiently recycle the metal or metal alloy from the chunks. Indeed, filters made of a fabric of metal threads gather at the bottom of the liquid metal or metal alloy (making them hard to recover), and they can partially dissolve into the re-melted metal or metal alloy to contaminate and/or modifying the chemistry of the same. Also, ceramic foam filters can partially disintegrate and contaminate the liquid metal, or gather in the bottom of the liquid metal, making hard to recapture the filters. On the other hand, existing filters made of a rigidified fabric of heat resistant fibers gather at the top of the liquid metal such that it is easier to recapture the filters. An easy and rapid recapturing of the filter is of economical interest.

Filters consisting of a rigidified fabric made from heat resistant fibers or threads made of heat resistant fibers, are of economic interest. Indeed, as the metal chunk (e.g. an aluminum chunk) results from the casting of a metal article into a mold, the chunk contains the fabric filter having filtered the liquid metal poured into the mold. When this chunk is recaptured and then re-melted for recycling purposes, contrary to filters made of steel threads which will gather at the bottom of the melting pots, filters made of rigidified heat resistant fibers float on top of the liquid metal or metal alloy to make them very easy to recapture.

Some attempts were made to embody fabric filters allowing the filtration of liquid metal (e.g. liquid aluminum or aluminum alloys) before being poured into a mold. Fabric made of heat resistant fibers or threads made of heat resistant fibers, are known. They have fibers (e.g. glass fibers) coated with a sizing material (e.g. starch). The existing fabric can be made of unwoven fibers (to form a felt of heat resistant fibers), or made of threads of heat resistant fibers. The threads are woven together according to weaving techniques well known to persons skilled in the art. According to the prior art, such fabric can be rigidified by applying thereon a rigidifying material to make it stiff enough to not being deformed by the pressure of a liquid metal passing through its opening, especially liquid aluminum. However, applying a rigidifying material on the sizing material of the heat resistant fibers reveals to provide serious drawbacks that will discourage a person skilled in the art using filters prepared this way.

The presence of a rigidifying material (i.e. a coating) shows several drawbacks that would discourage a person skilled in the art to consider using such filters for the filtration of liquid metal such as liquid aluminum or aluminum alloys. Indeed, the coating on the fibers of the resulting fabric shows the drawback of generating a clogging and/or partial obstruction of openings between threads (i.e. reducing the mesh size of the fabric filters). Also, because the protective/rigidifying coating is often brittle, particles may detach therefrom to contaminate the liquid aluminum, especially when applied on the sizing material of the fibers. Therefore, up to now, attempts for the replacement of such filters by filters made of a fabric of rigidified heat resistant fibers (e.g. of glass fibers or silica fibers) failed to be successful.

Indeed, contrary to filters made of a fabric of metal threads, existing filters made of a fabric of rigidified heat resistant fibers or threads of heat resistant fibers, are not stiff enough to prevent being deformed by the pressure of the liquid flowing through them, and therefore they fail to work properly (i.e. to efficiently perform the filtration of the liquid metal or the liquid metal alloy). Furthermore, even if existing filters made of a fabric of rigidified heat resistant fibers can be shaped to have an increased filtration surface, they show the drawbacks of having a meshing that may be partially clogged by the substances used for the rigidification of the fabric (thereby reducing the effective filtration surface of the filter). Finally, in some cases, even filters which are made of metal threads may be deformed by the flow of liquid metal or allow, and eventually driven within the cavity of the mold.

Therefore, there is a need in the industry for a fabric filters allowing the filtration of liquid metal, such as liquid aluminum or liquid aluminum alloys, while pouring the liquid metal into a mold, and without having the drawbacks associated with existing filters.

Some, but not all, foundries use magnetic placement of filters in openings of mold housings. This can either be a performed with a magnetic tool used by an operator for manual placement, or a magnetic tool attached to a robot for automated placement. Also, some but not all foundries use X-ray inspection to confirm the filters are properly positioned in the opening of mold housings. It is to be noted that handling of a filter may be difficult to incorporate into an automated and robotized process. Indeed, filters are usually placed across the inlet of the cavity of the mold manually with a tool grasping them.

Therefore, this is a need in the industry for filters that can be easily handled and positioned in openings of mold housings, especially with an automated robotized apparatus.

Moreover, there is a need for a filter made of a fabric of rigidified heat resistant fibers or threads of heat resistant fibers, allowing an easy or rapid recapturing of the filter from liquid metal resulting from chunks of metal obtained from molded articles, thereby defining an economical advantage over existing filters.

Furthermore, there is a need for a filter having a greater filtration surface by modifying its shape.

There is also a need in the metallurgic industry for a filter made of a fabric of heat resistant fibers or threads of the heat resistant fibers in any kind of casting processes using filters, more particularly a gravity casting process or a low-pressure casting process, without having the drawbacks associated with existing filters.

In addition, there is a need for improved filters that will prevent being deformed and/or driven by the pressure exerted by a flow of liquid metal or alloy passing there through during a casting process.

### SUMMARY

As embodied and broadly described herein, according to an embodiment, the invention provides a filter for filtering a liquid metal and to be received in a mold housing defined by internal side and face walls, the filter comprising a top wall and first, second, third and fourth side walls extending downwardly from the top wall, the first, second, third and fourth side walls being joined together at respective first, second, third and fourth corners, wherein, in use, the top wall is adapted to receive the liquid metal and the first, second, third and fourth side walls are adapted to at least partially contact respective first, second, third and fourth internal side walls of the mold housing in which the filter is received.

As embodied and broadly described herein, according to another embodiment, the invention provides a filter for filtering a liquid metal and to be received in a mold housing defined by internal side and face walls, the filter comprising a top wall and first, second, third and fourth side walls extending downwardly from the top wall, the first, second, third and fourth side walls being joined together at respective first, second, third and fourth corners, the first, second, third and fourth side walls extending downwardly towards first, second, third and fourth distal end portions, wherein the filter is made of a rigidified fabric of heat resistant fibers or threads of heat resistant fibers, and wherein the top wall and the first, second, third and fourth side walls have a first stiffness and wherein at least one of the first, second, third and fourth corners has a second stiffness, the second stiffness being higher than the first stiffness.

As embodied and broadly described herein, according to a further embodiment, the invention provides a filter for filtering a liquid metal and to be received in a mold housing defined by internal side and face walls, the filter comprising a top wall and at least three side walls extending downwardly from the top wall, the three side walls being joined together at three respective corners, wherein, in use, the top wall is adapted to receive the liquid metal and the three side walls are adapted to at least partially contact first, second and third internal side walls of the mold housing in which the filter is received.

With a filter having a top wall or filtering wall, and four side walls extending downwardly from the top wall up to four distal end portions where the four side walls define a quadrilateral (e.g. a rectangle or a square), such a filter allows an easy and consistent placement/position of the filter in the mold housing and ensures that the filter is maintained in place in the mold housing during casting since the side walls of the filter at least partially follow and contact the internal side walls of the mold housing.

With a filter having a top wall or filtering wall, and three side walls extending downwardly from the top wall up to three distal end portions where the three side walls define a triangle, such a filter allows an easy and consistent placement/position of the filter in the mold housing and ensures that the filter is maintained in place in the mold housing during casting since the side walls of the filter at least partially follow and contact the internal side walls of the mold housing.

With a filter made of a rigidified fabric of heat resistant fibers or threads of heat resistant fibers where the top wall and the side walls have a first stiffness and the corners have a second stiffness that is higher than the first stiffness, those corners increase the strength of the overall filter, while allowing a slight compression of the remainder of the filter to hold the filter in place without distorting the position or shape of the filter, and put the filter in a subtle but continual tension during casting, helping the filter to maintain its shape and integrity throughout casting.

### BRIEF DESCRIPTION OF THE DRAWINGS

A detailed description of the embodiments of the present invention is provided herein below, by way of example only, with reference to the accompanying drawings, in which:

FIG. 1 is a top perspective view of a filter in accordance with a first embodiment of the invention;

FIG. 2 is another top perspective view of the filter of FIG. 1;

FIG. 3 is a bottom view of the filter of FIG. 2;

FIG. 4 a top perspective view of a filter in accordance with a second embodiment of the invention;

FIG. 5 is another top perspective view of the filter of FIG. 4;

FIG. 6 is a bottom perspective view of a filter in accordance with a third embodiment of the invention;

FIG. 7 is a bottom perspective view of a filter in accordance with a fourth embodiment of the invention;

FIG. 8 is a bottom perspective view of a filter in accordance with a fifth embodiment of the invention;

FIG. 9 is a bottom perspective view of a filter in accordance with a sixth embodiment of the invention;

FIG. 10 is a perspective top view of a filter in accordance with a seventh embodiment of the invention;

FIG. 11 is a top view of the filter of FIG. 10;

FIG. 12 is a bottom perspective view of a filter in accordance with an eightieth embodiment of the invention;

FIG. 13 is a bottom perspective view of a filter in accordance with a ninetieth embodiment of the invention;

FIG. 14 is a top perspective view of the filter of FIG. 13;

FIG. 15 is a bottom perspective view of a filter in accordance with a tenth embodiment of the invention

FIG. 16 is a top perspective view of the filter of FIG. 15;

FIG. 17 is a bottom perspective view of a filter in accordance with an eleventh embodiment of the invention;

FIG. 18 is a schematic perspective view of a two-part mold;

FIG. 19 is a schematic perspective view of a part of the two-part mold of FIG. 18;

FIG. 20 is a schematic perspective view of a part of the two-part mold of FIG. 18 with a filter received in the mold housing; and

FIG. 21 is a graph showing strength results of filters as a function of deflection strength versus deflection.

In the drawings, embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF EMBODIMENTS

Before variants, examples or preferred embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including”, “comprising”, or “having” and variations thereof herein is meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “coupled” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. Variants, examples or preferred embodiments of the invention are discussed and described hereinbelow.

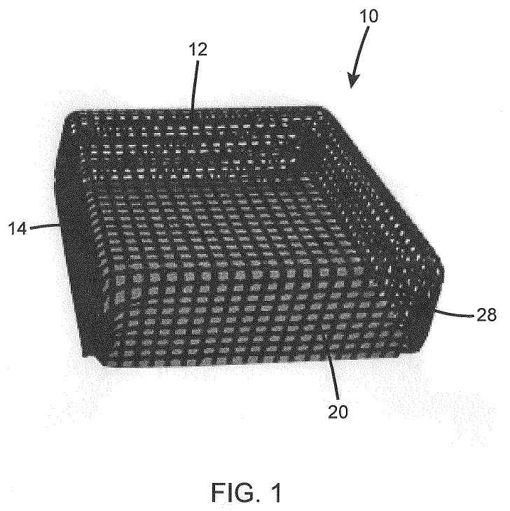

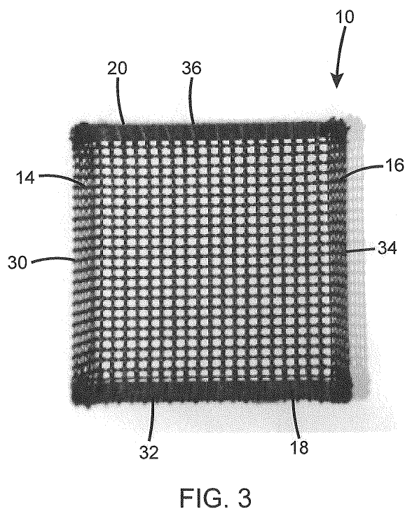

FIGS. 1 to 3 show a filter 10 for filtering a liquid metal. It is understood that the expression “liquid metal” includes any metal that is suitable to be used in metal casting processes (e.g. gravity casting process or low-pressure casting process) such as metals and alloys such as bronze, brass, aluminum, silver, lead, iron, etc. In use, the filter 10 is received in a mold housing defined by internal side and face walls.

Although the filter 10 can be made of any appropriate material, such as a grid of metal threads according to techniques well known in the art, the filters can be made of a fabric of heat resistant fibers, and more particularly of a fabric of a rigidified heat resistant material and composition as described in U.S. Publication 2017/0028466. In this publication, the following examples are described.

### EXAMPLE 1

A composition can be prepared as follows. In a first step, a mixture M is prepared by admixing the following ingredients together in a stainless steel container. More particularly, the ingredients of the mixture consisting of: (i) food graded table sucrose, (ii) tap water, (iii) laboratory grade phosphoric acid 75% wt., (iv) calcium phosphate monobasic, (v) aluminum ammonium sulfate. A 1 kg of mixture M containing 55.0 wt % of sucrose, 41.5 wt % of tap water, 1.1 wt % of phosphoric acid 75% wt., 1.0 wt % aluminium ammonium sulfate, and 1.4 gr (1.4 wt %) calcium phosphate monobasic is prepared by adding into the container, 550 gr of sucrose, 41.5 gr of tap water, 1.1 gr of phosphoric acid 75%, 1.0 gr of aluminum ammonium sulfate, and 1.4 gr of calcium phosphate monobasic, and then mixed together with a paint mixer until obtaining the mixture M. Then, the mixture M is subjected to heating until a temperature of 100° C. to 103° C. was reached for at least 5 minutes, to thereby form a caramel defining a product A. The product A is thereafter allowed to cool at room temperature. In a second step, 515 gr. of a product B which is a colloidal dispersion of submicron-sized silica particles in the form of tiny spheres, in an alkaline aqueous solution and sold under the trademark NALCO 1144®, is added to the 1.0 kg of the product A obtained in the previous step, and then ingredients A and B are mixed together with the paint mixer. The mixing was carried out at room temperature until a homogeneous composition was obtained (i.e. about 10 minutes). The composition was comprising about 66 wt % of the product A and about 34 wt % of the product B.

### EXAMPLE 2

A fabric of glass fibers that is substantially free of a sizing material consisting of starch is prepared. The fabric of glass fiber that can be used as a starting material may be fabrics made of threads of glass fibers coated with starch. More particularly, the fabric may be selected amongst those listed in the following table:

Fiberglass filtration product - with starch coating
Specification table (metric values)

| | Thread | | | | | | |
|---|---|---|---|---|---|---|---|
| | Diameter | | Thread | Holes | Opening | Open | |
| Style | Warp | Fill | Count | Per | Sizes | area | Weave |
| Number | mm | mm | Per cm² | cm² | Per cm² | % | Type |
| 34L | 0.864 | 0.940 | 34.3 × 29 | 10 | 0.0512 | 50.9 | Leno |
| 34P4 | 0.787 | 1.016 | 37.3 × 31 | 12 | 0.0418 | 48.4 | Plain |
| 36F | 0.686 | 1.118 | 40.9 × 34 | 14 | 0.0321 | 44.6 | Plain |
| 36L | 0.914 | 0.864 | 38.4 × 36 | 14 | 0.0322 | 44.5 | Leno |
| 36P | 0.686 | 0.838 | 40.9 × 37.8 | 15 | 0.0315 | 48.7 | Plain |
| 36P4 | 0.787 | 1.067 | 37.3 × 41 | 15 | 0.0260 | 39.7 | Plain |
| 40F | 0.686 | 1.118 | 40.9 × 37.8 | 15 | 0.0269 | 41.6 | Plain |
| 40L | 0.940 | 0.864 | 43.8 × 36 | 16 | 0.0255 | 40.3 | Leno |
| 40P | 0.686 | 0.838 | 44.9 × 44.4 | 20 | 0.0218 | 43.5 | Plain |
| 40P4 | 0.813 | 0.991 | 36.8 × 34.1 | 13 | 0.0368 | 46.3 | Plain |
| 42F | 0.762 | 1.118 | 44.9 × 38 | 17 | 0.0222 | 37.8 | Plain |
| 42P | 0.737 | 0.864 | 44.9 × 46.5 | 21 | 0.0191 | 40.1 | Plain |
| 43FK | 0.762 | 1.118 | 54 × 42 | 23 | 0.0138 | 31.2 | Plain |
| 43P | 0.737 | 1.864 | 54 × 50.6 | 27 | 0.0124 | 33.9 | Plain |
| 43P4 | 0.889 | 1.168 | 54 × 47 | 25 | 0.0092 | 24.3 | Plain |
| 55F | 0.533 | 0.787 | 65.8 × 56.9 | 37 | 0.0095 | 35.9 | Plain |

Product 40L may be used as starting material. In Example 2, a fabric of glass fibers of the type 40L coated with a layer of starch (as a sizing agent) is subjected to a heat treatment in an oven at 450° C. for about 2 minutes, to burnout the starch (in the presence of oxygen) and thereby remove the sizing agent.

### EXAMPLE 3

A rigidified thermoplastic fabric of glass fibers is prepared wherein a fabric of glass fibers as obtained from Example 2 is impregnated with the composition of Example 1 to obtain a fabric impregnated with the composition. More particularly, the fabric is passed in a reservoir containing the composition and then between a pair of opposite rubber-rolls of a two-rollers impregnator. The impregnated fabric so obtained is then subjected to a heating treatment in a continuous oven at a temperature of about 160° C. for about 2 minutes to place the composition impregnated therein into a softened thermoplastic state. Then, the thermosettable fabric so obtained (i.e. impregnated with the composition transformed into a thermoplastic state) is ready to be used for further treatments such as an optional forming the thermoplastic fabric into a desired size and/or shape, and then a thermosetting treatment to thermoset the composition and provide a rigidified fabric of the heat resistant glass fibers. If not used immediately, the fabric may be allowed to cool at room temperature.

### EXAMPLE 4

The fabric impregnated with the composition obtained from Example 3 is cut into a flat sheet and then is subjected to a thermosetting treatment in an oven at 450° C. for 2 minutes to rigidify the fabric of the glass fibers. This rigidified fabric which originates from the 40L type fabric of glass fiber has openings of 0.0255 cm².

### EXAMPLE 5

The thermoplastic fabric obtained from Example 3 cooled at room temperature is cut into a flat sheet and then placed in a hot mold consisting of a pair of opposite mold halves, to thereby soften and mold the flat sheet of fabric into a desired shape by compression-molding. Then, the shaped fabric so obtained is ready to be used for further treatments such as a thermosetting treatment to thermoset the composition and provide a rigidified fabric of the heat resistant glass fibers.

### EXAMPLE 6

The shaped fabric obtained from Example 5 is subjected to a thermosetting treatment in an oven at 450° C. for 2 minutes to rigidify the fabric of the glass fibers of the threads. This shaped rigidified fabric which originates from a 40L type fabric of glass fiber has openings of 0.0255 cm².

### EXAMPLE 7

The fabric obtained from Example 3 is cut into a flat sheet and while being still in a softened thermoplastic state, placed in a cold mold consisting of a pair of opposite mold halves, to thereby obtain a fabric into a desired shape by compression-molding. Then, the shaped fabric so obtained is subjected to a thermosetting treatment in an oven at 450° C. for 2 minutes to rigidify the fabric of the glass fibers. The shaped rigidified fabric so obtained can be used as a filter for liquid metal, especially in a low-pressure casting process or gravity casting process.

### EXAMPLE 8

A rigidified fabric of glass fibers is prepared wherein a fabric of threads of glass fibers as obtained from Example 2 is impregnated according to Example 3 with the composition of Example 1 to obtain a fabric impregnated with the composition. More particularly, the fabric is passed successively across the composition and then between pair of opposite rubber-rolls, which are pressed one against the other, to push an amount of the composition within the openings existing between fibers of the threads forming the fabric. The impregnated fabric so obtained is then subjected to a heating treatment in a continuous oven at a temperature of about 160° C. for about 2 minutes to place the composition impregnated therein into a softened thermoplastic state. Then, the fabric so obtained (i.e. impregnated with the composition transformed into a thermoplastic state) is ready to be used for further treatments such as an optional forming the thermoplastic fabric into a desired shape, and then a thermosetting treatment to thermoset the composition and provide a rigidified fabric of the heat resistant glass fibers of the threads. If not used immediately, the fabric may be allowed to cool at room temperature.

### EXAMPLE 9

The fabric obtained from Example 8 and cooled at room temperature is cut into a flat sheet and then placed in a hot mold consisting of a pair of opposite mold halves to thereby soften and mold a filter having a particular structural shape and orientation, by compression-molding. Then, the shaped fabric is allowed to cool. Compression molding is carried out at about 160° C. The shaped fabric so obtained is ready to be used for further treatments such as a thermosetting treatment to thermoset the composition and provide a rigidified fabric of the heat resistant glass fibers of the threads of glass fibers.

Hence, according to embodiments of the invention, the filter 10 may be made of a rigidified fabric of heat resistant fibers or threads of heat resistant fibers. The fibers may be impregnated with a composition comprising a mixture of a first product obtained by polymerisation of saccharide units and a second product consisting of at least one inorganic colloidal binding agent. The fibers may be glass fibers, silica fibers or a mixture thereof, impregnated with a first product obtained by caramelization of a mixture comprising sucrose, water, and at least one additive selected from the group consisting of acids, inorganic wetting agents and acid phosphate adhesives

Reverting to FIGS. 1 to 3, the filter 10 comprises a top wall 12, or filtering wall, which is normally the main filtering portion of the filter 10 and is to be located transverse to the liquid flow in use. The filter 10 also comprises a first side wall 14, a second side wall 16, a third side wall 18 and a fourth side wall 20 extending downwardly from the top wall 12. The first, second, third and fourth side walls are joined together at respective first, second, third and fourth corners 22, 24, 26, 28. Moreover, the first, second, third and fourth side walls 14, 16, 18, 20 extend downwardly towards first, second, third and fourth distal end portions 30, 32, 34, 36.

The filter may be made of a flat sheet of fabric of Example 3 or Example 8 discussed hereinabove. Before the thermoforming or compression-molding process, the sheet of fabric may be cutaway in the corner(s) (i.e. rounded cut). During the thermoforming or compression-molding process, the sheet of fabric is thermoformed/molded such that the corners are formed without bunching.

It is understood that the filter 10 may be made in a thermoforming or compression-molding process where a pre-cut sheet of fabric with fibers is inserted into the cavity of one of a male-female mold. The male and female portions of the molds define the inner and outer surfaces of filter. For instance, the male portion of the molds defines the inner surfaces of the filter whereas the female portion of the molds defines the outer surfaces of the filters. The pre-cut sheet may be aligned and temporarily secured to one of the mold portions using any suitable means to accurately position the pre-cut sheet within the mold and maintain same in position when the mold is closed. Once the mold is closed over the pre-cut sheet, the mold is heated up to the thermoforming temperature of the pre-cut sheet and male and female portions are pressed against the pre-cut sheet so that the pre-cut sheet will set to the three-dimensional shape defined by the male and female portions of the mold.

After the thermoforming or compression-molding process, it is understood that the shaped filter so obtained is ready to be used for further treatments such as a thermosetting treatment to thermoset the composition and provide a rigidified filter of the heat resistant glass fibers. By utilizing different sheets of fabric with fibers, different materials, or the same material with different fibers densities, the designers are able to vary the mechanical properties of the filter.

The top wall 12 and the first, second, third and fourth side walls 14, 16, 18, 20 may have a first stiffness and the first, second, third and fourth corners 22, 24, 26, 28 may have a second stiffness wherein the second stiffness is higher than the first stiffness. The top wall 12 and the first, second, third and fourth side walls 14, 16, 18, 20 may have a first fibers density and the first, second, third and fourth corners 22, 24, 26, 28 may have a second fibers density wherein the second fiber density is higher than the first fiber density. The top wall 12 and the first, second, third and fourth side walls 14, 16, 18, 20 may be construed as a first substructure with a first stiffness and the first, second, third and fourth corners 22, 24, 26, 28 may be together construed as a second substructure having a second stiffness, wherein the second stiffness is greater than the first stiffness. The first, second, third and fourth corners 22, 24, 26, 28 thus define stiffening corners that provide reinforcement in the corner regions and that increase the overall strength, stiffness or rigidity of the filter 10.

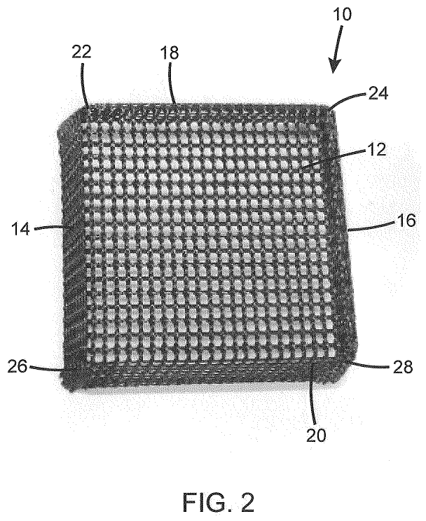

As seen in FIG. 2, the first and third side walls 14, 18 oppose the second and fourth side walls 16, 20 and the first, second, third and fourth side walls 14, 16, 18, 20 define a quadrilateral (e.g. parallelogram, a trapezium, a rhombus, a kite, a rectangle or a square). In another variant, the filter may have a top wall with five side walls extending downwardly from the top wall and joined together at five stiffening corners where the five side walls define a shape such as a pentagon. In a further variant, the filter may have a top wall with six side walls extending downwardly from the top wall and joined together at six stiffening corners where the six side walls define a shape such as a hexagon. In another variant, the filter may have a top wall with eight side walls extending downwardly from the top wall and joined together at eight stiffening corners where the eight side walls define a shape such as an octagon.

As it is well known in the art, filtering efficiency depends on correct placement of the filter in the mold housing since filters are typically designed to work in one orientation Because the filter may have three, four, five, six or eight side walls defining a shape such as a triangle, rectangle, square, pentagon, hexagon or octagon, this minimize the chance of the filter being placed with incorrect orientation within the mold housing since the walls are adapted to follow or contact the internal side walls of the mold housing.

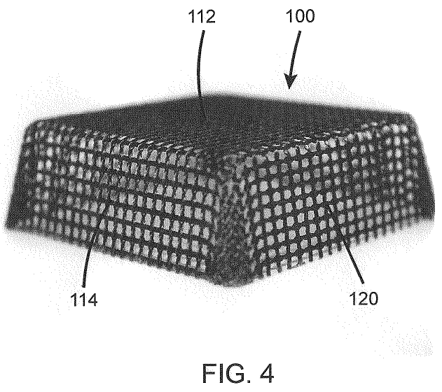

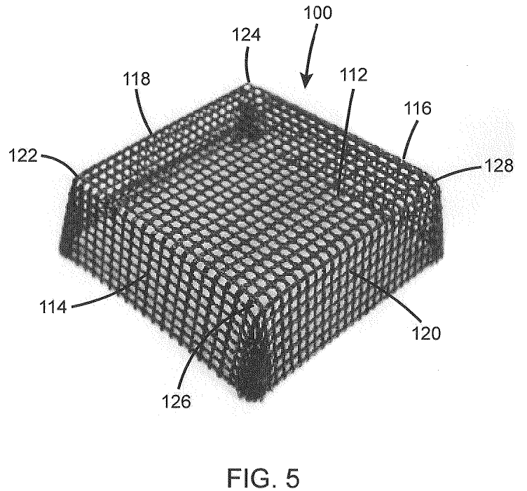

FIGS. 4 and 5 show a filter 100 that generally corresponds to the filter 10 except that the filter 100 has first, second, third and fourth side walls 114, 116, 118, 120 where each side wall extends downwardly and outwardly from the top face 112 such that the filter 100 has a frustopyramidal shape. In this variant, the filter 100 is adapted to allow stacking of a second filter into it. The filter 100 has first, second, third and fourth corners 122, 124, 126, 128.

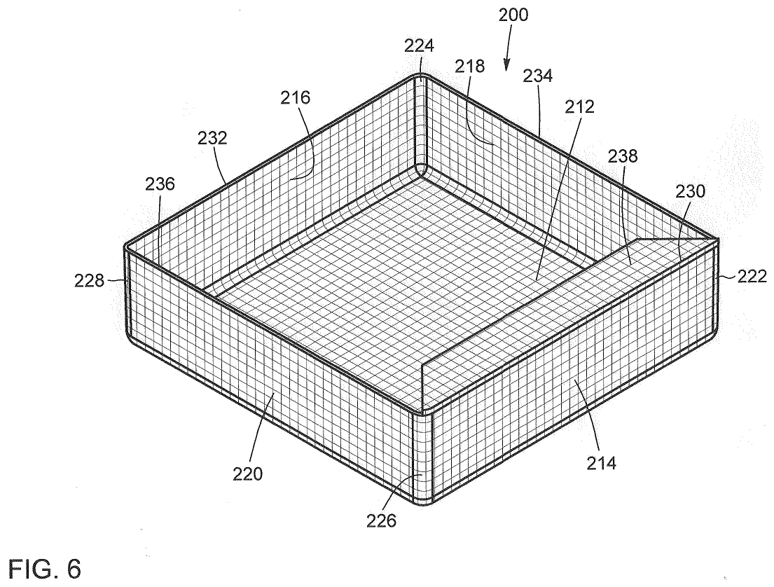

FIG. 6 shows a filter 200 that generally corresponds to the filter 10 except that the filter 200 has first, second, third and fourth side walls 214, 216, 218, 220 extending downwardly from the top wall 212 towards first, second, third and fourth distal end portions 230, 232, 234, 236, wherein the distal end portion 230 has a first facing end portion 238 extending inwardly from the first distal end portion 230. The filter 200 has first, second, third and fourth corners 222, 224, 226, 228.

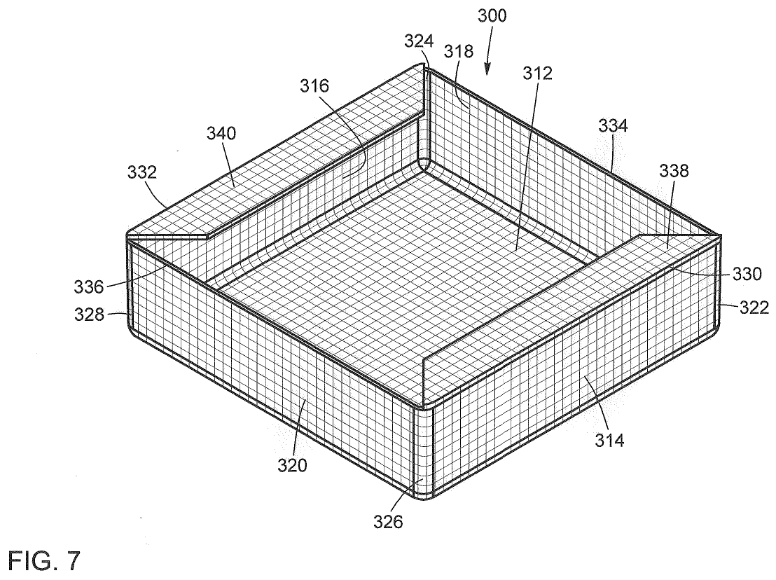

FIG. 7 shows a filter 300 that generally corresponds to the filter 10 except that the filter 300 has first, second, third and fourth side walls 314, 316, 318, 320 extending downwardly from the top wall 312 towards first, second, third and fourth distal end portions 330, 332, 334, 336, wherein the first distal end portion 330 has a first facing end portion 338 extending inwardly from the first distal end portion 330 and the second distal end portion 332 has a second facing end portion 340 extending inwardly from the second distal end portion 332. The filter 300 has first, second, third and fourth corners 322, 324, 326, 328.

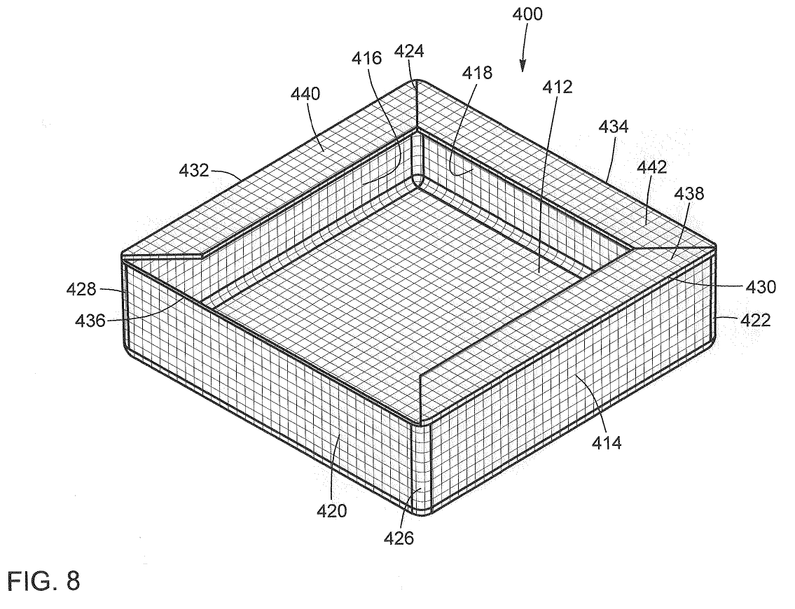

FIG. 8 shows a filter 400 that generally corresponds to the filter 10 except that the filter 400 has first, second, third and fourth side walls 414, 416, 418, 420 extending downwardly from the top wall 412 towards first, second, third and fourth distal end portions 430, 432, 434, 436, wherein the first distal end portion 430 has a first facing end portion 438 extending inwardly from the first distal end portion 430, the second distal end portion 432 has a second facing end portion 440 extending inwardly from second first distal end portion 432, and the third distal end portion 434 has a third facing end portion 442 extending inwardly from the third distal end portion 434. The filter 400 has first, second, third and fourth corners 422, 424, 426, 428.

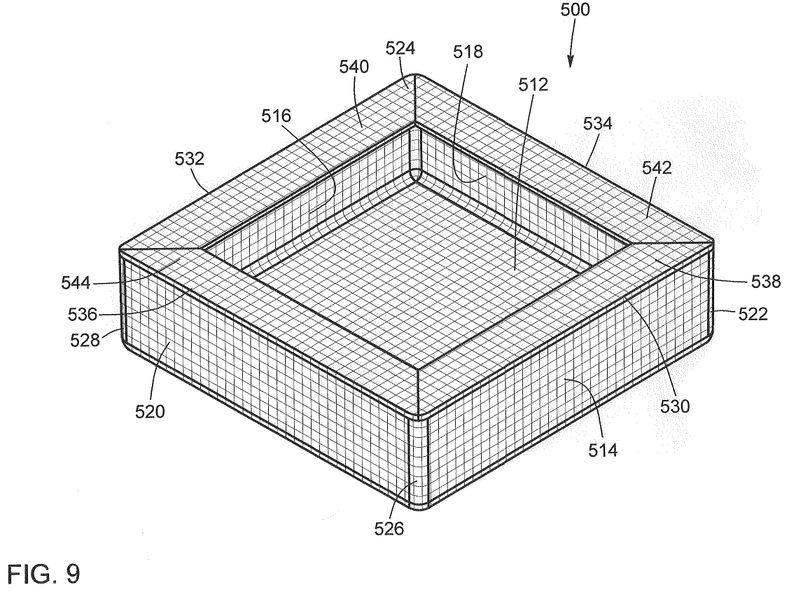

FIG. 9 shows a filter 500 that generally corresponds to the filter 10 except that the filter 500 has first, second, third and fourth side walls 514, 516, 518, 520 extending downwardly from the top wall 512 towards first, second, third and fourth distal end portions 530, 532, 534, 536, wherein the first distal end portion 530 has a first facing end portion 538 extending inwardly from the first distal end portion 530, the second distal end portion 532 has a second facing end portion 540 extending inwardly from the second distal end portion 532, the third distal end portion 534 has a third facing end portion 542 extending inwardly from the third distal end portion 534, and the fourth distal end portion 536 has a fourth facing end portion 544 extending inwardly from the fourth distal end portion 536. The filter 500 has first, second, third and fourth corners 522, 524, 526,528.

It is understood that each of the first, second, third and fourth side walls of the filters 200, 300, 400, 500 may extend downwardly and outwardly from the top face such that the filter has a frustopyramidal shape.

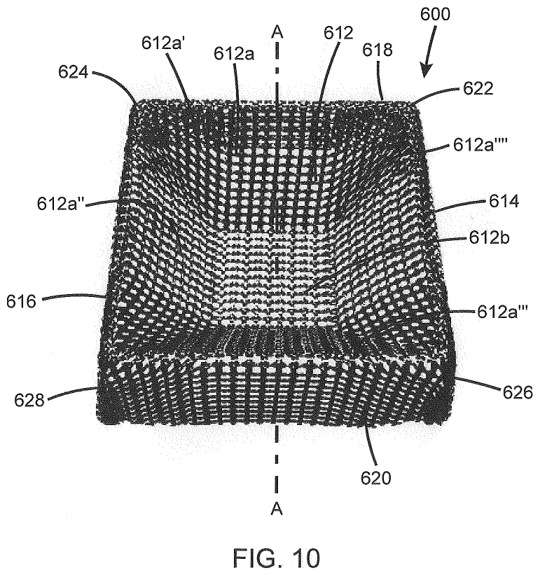

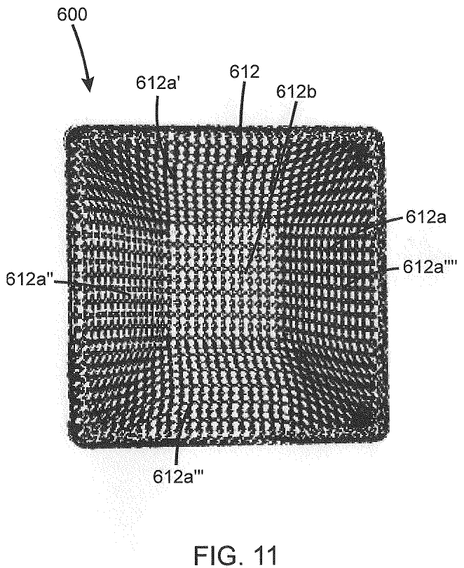

FIGS. 10 and 11 show a filter 600 that generally corresponds to the filter 10 except that the filter 600 has a top wall 612 that is different than the top wall 12. The filter 600 has first, second, third and fourth side walls 614, 616, 618, 620 extending downwardly from the top wall 612. The filter 600 has first, second, third and fourth corners 622, 624, 626, 628. The filter 600 extends along a longitudinal axis A-A residing within an imaginary longitudinal plane that bisects the filter 600 in two halves, wherein the top wall 612 comprises a first portion 612a and a second portion 612b connected to the first portion 612a, the second portion 612b extending transversely with respect to the longitudinal axis A-A and being located downwards the first portion 612a along the longitudinal axis A-A. The first portion 612a defines a first filtering surface and the second portion 612b defines a second filtering surface. In the filter 600, the first surface 612a is defined by first, second, third and fourth trapezium surface portions 612a′, 612a″, 612a″′, 612a″″ and the second surface 612b is a square surface. The second portion 612b is centrally located with respect to the longitudinal axis A-A passing through the center of the filter. The first and second portions 612a, 612b define an internal protuberance for handling the filter 600 with a tool or gripping device.

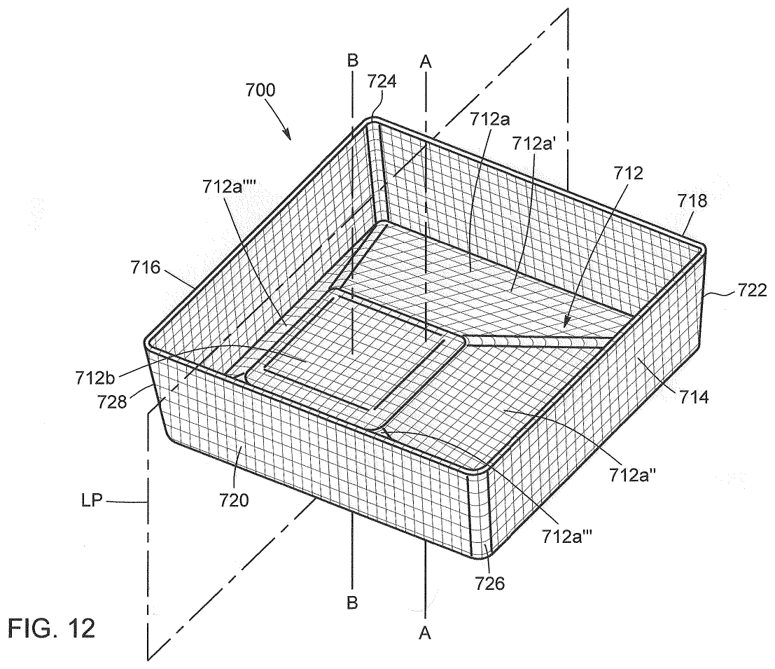

FIG. 12 shows a filter 700 that generally corresponds to the filter 10 except that the filter 700 has a top wall 712 that is different than the top wall 12. The filter 700 has first, second, third and fourth side walls 714, 716, 718, 720 extending downwardly from the top wall 712. The filter 700 has first, second, third and fourth corners 722, 724, 726, 728. The filter 700 extends along a longitudinal axis A-A residing within an imaginary longitudinal plane LP that bisects the filter 700 in two halves, wherein the top wall 712 comprises a first portion 712a and a second portion 712b connected to the first portion 712a, the second portion 712b extending transversely with respect to the longitudinal axis A-A and being located downwards the first portion 712a along the longitudinal axis A-A. The first portion 712a defines a first filtering surface and the second portion 712b defines a second filtering surface. In the filter 700, the first surface 712a is defined by first, second, third and fourth trapezium surface portions 712a′, 712a″, 712a″′, 712a″″ and the second surface 712b is a square surface. The filter 700 also extends along a longitudinal axis B-B, which is parallel to the longitudinal axis A-A, and the second portion 712b is centrally located with respect to the longitudinal axis B-B. The first and second portions 712a, 712b define an internal protuberance for handling the filter 700 with a tool or gripping device.

It is understood that each of the first, second, third and fourth side walls 614, 616, 618, 620 and 714, 716, 718, 720 may extend downwardly and outwardly from the top wall such that the filters 600, 700 each has a frustopyramidal shape and each is adapted to allow stacking of a second filter into the filter.

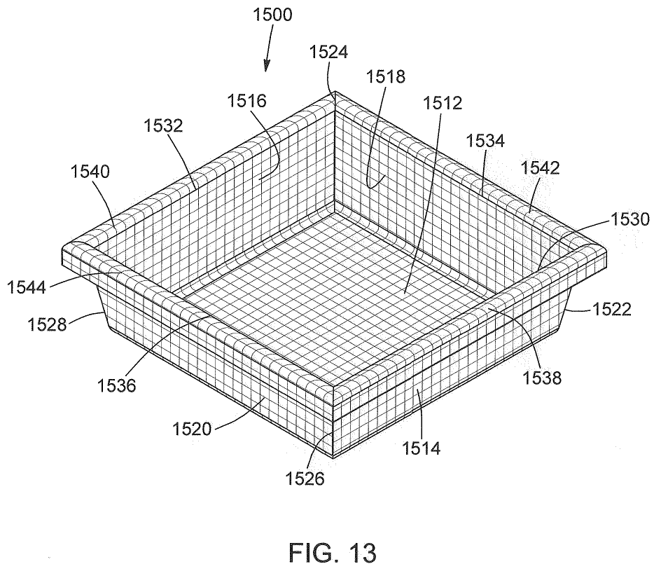

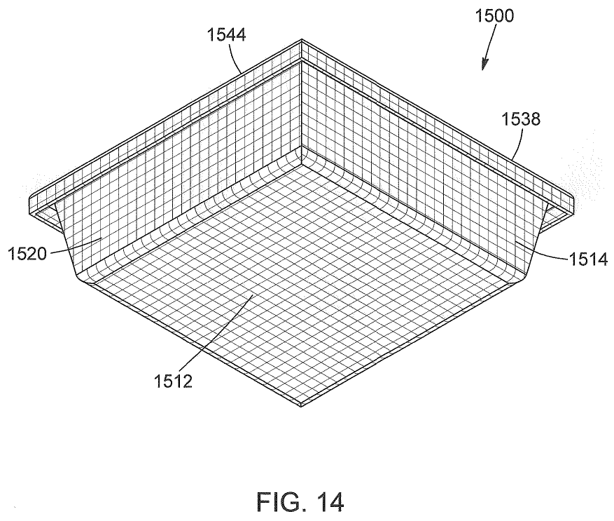

FIGS. 13 and 14 show a filter 1500 that generally corresponds to the filter 10 except that the filter 1500 has first, second, third and fourth side walls 1514, 1516, 1518, 1520 extending downwardly from the top wall 1512 towards first, second, third and fourth distal end portions 1530, 1532, 1534, 1536, wherein the first distal end portion 1530 has a first facing end portion 1538 extending outwardly from the first distal end portion 1530, the second distal end portion 1532 has a second facing end portion 1540 extending outwardly from the second distal end portion 1532, the third distal end portion 1534 has a third facing end portion 1542 extending outwardly from the third distal end portion 1534, and the fourth distal end portion 1536 has a fourth facing end portion 1544 extending outwardly from the fourth distal end portion 1536. The filter 1500 has first, second, third and fourth corners 1522, 1524, 1526, 1528.

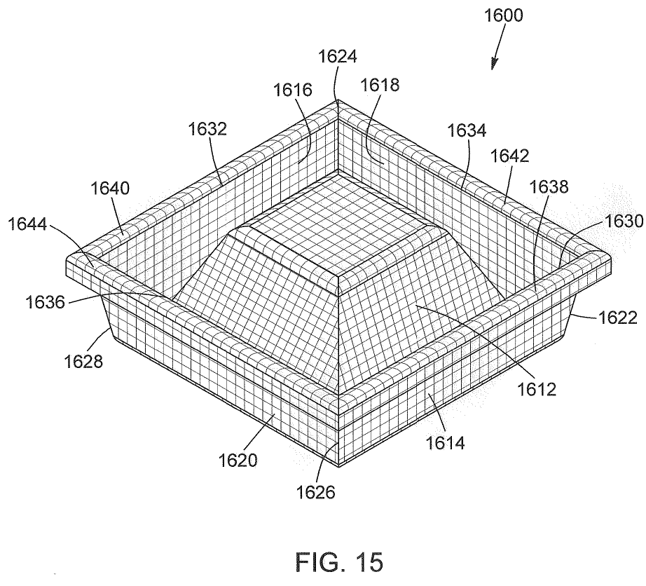

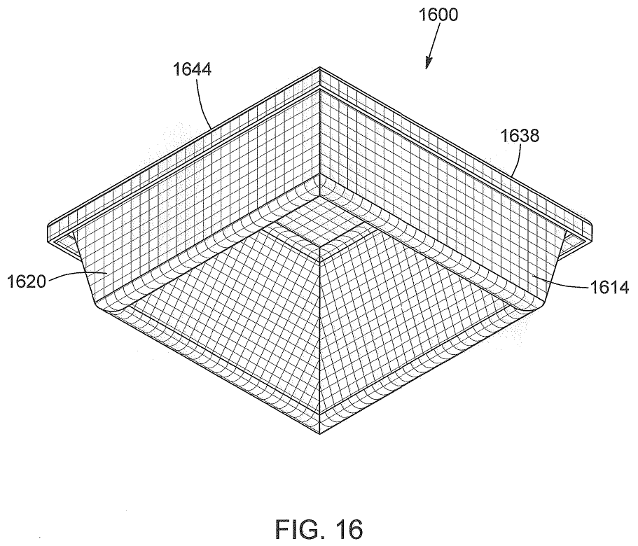

FIGS. 15 and 16 show a filter 1600 that generally corresponds to the filter 600 except that the filter 1600 has a top wall 1612, first, second, third and fourth side walls 1614, 1616, 1618, 1620 and first, second, third and fourth distal end portions 1630, 1632, 1634, 1636, wherein the first distal end portion 1630 has a first facing end portion 1638 extending outwardly from the first distal end portion 1630, the second distal end portion 1632 has a second facing end portion 1640 extending outwardly from the second distal end portion 1632, the third distal end portion 1634 has a third facing end portion 1642 extending outwardly from the third distal end portion 1634, and the fourth distal end portion 1636 has a fourth facing end portion 1644 extending outwardly from the fourth distal end portion 1636. The filter 1600 has first, second, third and fourth corners 1622, 1624, 1626, 1628.

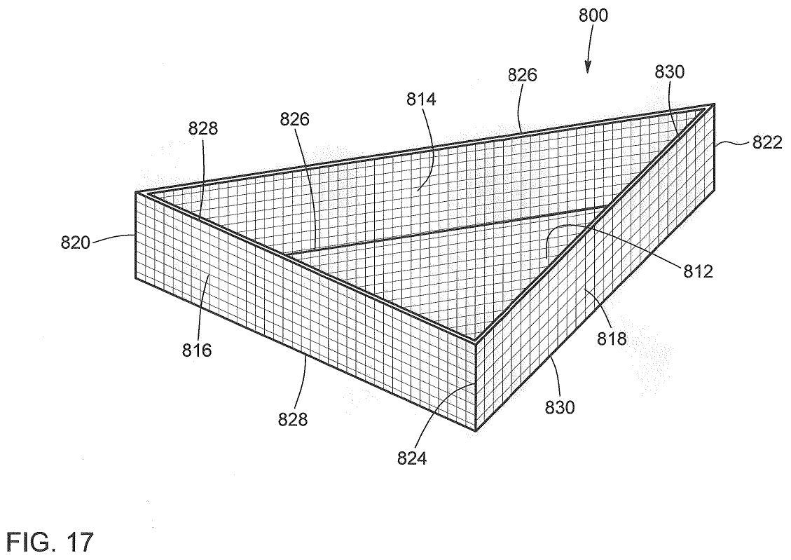

FIG. 17 shows a filter 800 in accordance with another variant. The filter 800 comprises a top wall 812 and three side walls 814, 816, 818 extending downwardly from the top wall 812 and that are joined together at three respective corners 820, 822, 824. In this variant, the three side walls 814, 816, 818 define a triangle. The side walls extend towards first, second and third distal end portions 826, 828, 830. The three corners 820, 822, 824 are stiffening corners after the thermoforming or compression-molding process since these corners have higher stiffness, higher fiber density or define a substructure with higher stiffness or rigidity. In use, the top wall 812 is adapted to receive the liquid metal and the three side walls 814, 816, 818 are adapted to at least partially contact the internal side walls of the mold housing in which the filter 800 is received. The filter 800 may be made of a rigidified fabric of heat resistant fibers or threads of heat resistant fibers. The fibers may be impregnated with a composition comprising a mixture of a first product obtained by polymerisation of saccharide units and a second product consisting of at least one inorganic colloidal binding agent. The fibers may be glass fibers, silica fibers or a mixture thereof, impregnated with a first product obtained by caramelization of a mixture comprising sucrose, water, and at least one additive selected from the group consisting of acids, inorganic wetting agents and acid phosphate adhesives.

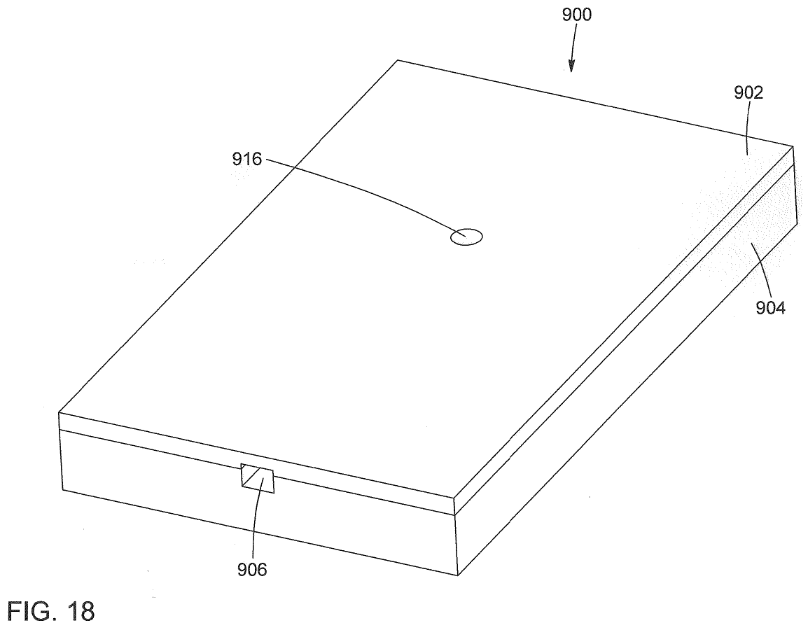

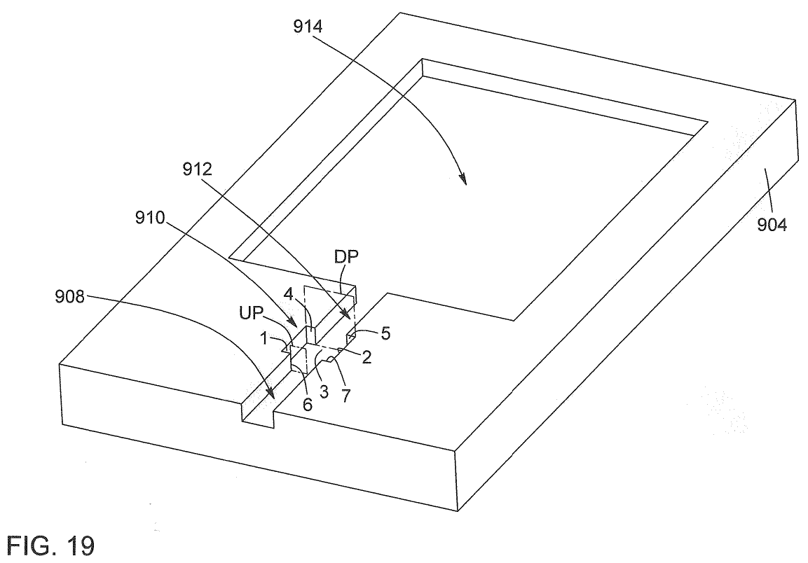

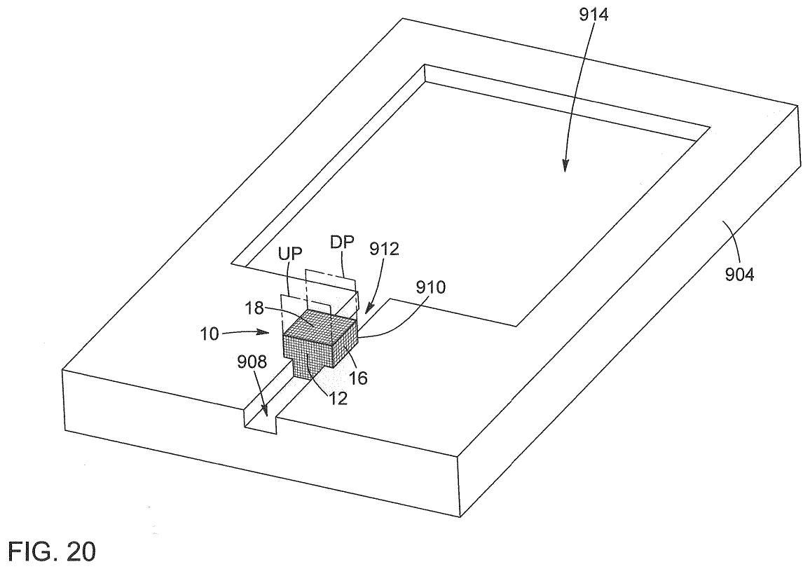

FIG. 18 show a two-part mold 900 comprising a first part 902 and a second part 904 which are each provided with an internal cavity 906 when both parts are maintained and pressed one against the other. As best shown in FIGS. 19 and 20, in the second part 904, an inlet conduit 908, a mold housing 910, an outlet conduit 912 and a mold cavity 914 are provided. It is understood that the second part may have corresponding inlet conduit, mold housing, outlet conduit and mold cavity and that the internal cavity 906 of the mold 900 is then defined by the inlet conduits, mold housings, outlet conduits and mold cavities of the first and second parts 902, 904. The first part 902 also comprises an opening or internal conduit 916 for allowing air contained within the mold cavity to escape during the filling of the mold cavity with liquid metal. The inlet and outlet conduits 908, 912 are in fluid communication with the mold housing 910 such that liquid metal flowing in the conduits 908, 912 also passes through the mold housing 910 where a filter is to be received.

As best shown in FIG. 20, the mold housing is defined by a first internal side wall 1, a second internal side wall 2, and a third internal side wall 3. It is understood that the mold housing may be defined by first, second and third internal side walls provided in the second part. The mold housing is further defined by a first internal face wall 4 and a second internal face wall 5. Again, it is understood that the mold housing may be defined by first and second internal face walls provided in the second part. The mold housing is also defined by a first internal back wall 6 and a second internal back wall 7. Again, it is understood that the mold housing may be defined by first and second internal back walls provided in the second part. The first and second internal face walls can be also designated as first and second downstream walls located in a downstream plane DP that is transverse to the flow of the liquid metal and the opposite internal back walls can be designated as upstream walls located in an upstream plane UP transverse to the flow of the liquid metal.

FIG. 20 shows the filter 10 received in the mold housing 910. In use, liquid metal is poured into the inlet conduit 908 to flow through the inlet conduit 908 towards the filter 10 positioned in the mold housing 910, where the liquid metal is filtered, and then into the outlet conduit 912 and the cavity 914 itself. This process of pouring liquid metal into the two-part mold 900 is called gravity casting process. Once the liquid metal has cool, both parts 902, 904 of the two-part mold 900 are separated and the solid article is removed.

In use, the filter may be placed in the mold housing 910 such that the top wall or filtering wall of the filters 10, 100, 200, 300, 400, 500, 600, 700, 1500, 1600, 800 is in an imaginary filtering section that is transverse to the flow of the liquid metal and that is adjacent to the upstream plane UP and such that parts of the first, second, third and fourth distal end portions of the filters 10, 100, 200, 300, 400, 500, 600, 700 1500, 1600 are adapted to abut against two face walls of the mold housing and parts of the first, second and third distal end portions of the filter 800 are adapted to abut against three face walls of the mold housing.

Alternatively, in use, the filter may be placed in the mold housing 910 in another orientation, or reverse orientation, such that the top wall or filtering wall of the filters 10, 100, 600, 700, 1500, 1600, 800 is in an imaginary filtering section that is transverse to the flow of the liquid metal and that is adjacent to the downstream plane DP and such that parts of the top wall are adapted to abut against first and second face walls of the mold housing.

In addition, in use, the first, second, third and fourth side walls of the filters 10, 100, 200, 300, 400, 500, 600, 700, 1500, 1600, and the first, second and third side walls of the filter 800 are adapted to follow and contact respective side walls of the mold housing. In use, because of the shape of the side walls of the filters 10, 100, 200, 300, 400, 500, 600, 700, 1500, 1600, 800 that are joined together at corners, each filter allows an easy and consistent placement/position of the filter in the mold housing and ensures that the filter is maintained in place in the mold housing during casting since the side walls of the filter at least partially follow and contact internal side walls of the mold housing.

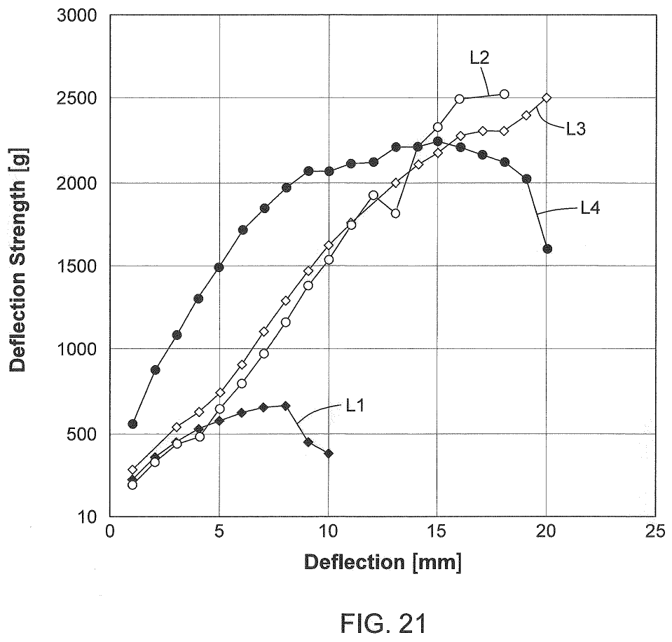

Filters 10, 100, 200, 300, 400, 500, 600, 700, 1500, 1600, 800 made of a rigidified fabric of heat resistant fibers or threads of heat resistant fibers where the top wall and side walls have a first stiffness and the corners have a second stiffness that is higher than the first stiffness, those corners increase the strength of the overall filter, those corners, or a combination of those corners and side walls and top wall, may also allow a slight compression of the filter to hold the filter in place without distorting the position or shape of the filter, and those corners, or a combination of those corners and side walls and top wall, may put the filter in a subtle but continual tension during casting, helping the filter to maintain its shape and integrity throughout casting. Each of the filters 10, 100, 200, 300, 400, 500, 600, 700, 1500, 1600, 800 has a strength, stiffness or rigidity that is higher than the one of existing filters. In fact, the strength of the filter of the invention may be at least two times greater than the one of the “M” shape filter disclosed in U.S. Publication 2017/0028466. In this regard, FIG. 21 shows strength results of filters as a function of deflection strength versus deflection where line L1 shows strength results for a filter similar to the “M” shape filter disclosed in U.S. Publication 2017/0028466, lines L2 and L3 show strength results for a filter such as filters 200, 300, 400, 500, 1500 and line L4 shows strength results for a filter such as filters 600, 700, 1600.

The above description of the embodiments should not be interpreted in a limiting manner since other variations, modifications and refinements are possible within the scope of the present invention. Accordingly, it should be understood that various features and aspects of the disclosed embodiments can be combined with or substituted for one another in order to form varying modes of the disclosed invention. The scope of the invention is defined in the appended claims and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A method of casting a metal object, comprising:
supplying a liquid metal toward a mold; and
filtering the liquid metal prior to entry into the mold to produce a filtered liquid metal;
wherein the filter comprises:
a top wall and first, second, third and fourth side walls extending downwardly from the top wall, the first, second, third and fourth side walls being joined together at respective first, second, third and fourth corners, the first, second, third and fourth side walls extending downwardly towards first, second, third and fourth distal end portion;
wherein the filter is made of a rigidified fabric comprising heat resistant fibers or threads of heat resistant fibers, and is obtained by moulding and hardening of a flat sheet of a fabric comprising the heat resistant fibers or the threads of heat resistant fibers to form said top wall, and said first, second, third, fourth side walls and said first, second, third and fourth corners;
wherein the top wall and the first, second, third and fourth side walls have a first fibers density and the first, second, third and fourth corners have a second fiber density, the second fiber density being higher than the first fiber density such that the first, second, third and fourth corners define first, second, third and fourth stiffening corners;
wherein each of the first, second, third and fourth stiffening corners corresponds to a thickening of corresponding adjacent portions of said first, second, third and fourth sidewalls, said first, second, third and fourth stiffening corners extending downwardly from the top wall;
wherein each of the first, second, third and fourth stiffening corners supports the top wall;
wherein the first, second, third and fourth side walls are supported by the respective first, second, third and fourth stiffening corners;
wherein the top wall and the first, second, third and fourth side walls have a first stiffness;
wherein the first, second, third and fourth stiffening corners have a second stiffness, the second stiffness being higher than the first stiffness; and
wherein the filter has a deflection strength, said deflection strength being obtained by the support of the top wall and the first, second, third and fourth side walls through which the liquid metal is to be filtered, by the first, second, third and fourth stiffening corners; and
supplying the filtered liquid metal into the mold.

34. The method of claim 33, wherein the fibers are impregnated with a composition comprising a mixture of a first product obtained by polymerisation of saccharide units and a second product consisting of at least one inorganic colloidal binding agent.

35. The method of claim 33, wherein the fibers are glass fibers, silica fibers or a mixture thereof, impregnated with a first product obtained by caramelization of a mixture comprising sucrose, water, and at least one additive selected from the group consisting of acids, inorganic wetting agents and acid phosphate adhesives.

36. The method of claim 33, wherein the first and third side walls oppose the second and fourth side walls and wherein the first, second, third and fourth side walls define a quadrilateral.

37. The method of claim 33, wherein the first, second, third and fourth side walls have first, second, third and fourth distal end portions, and wherein, in use, the top wall is located in a filtering section that is transverse to a flow of the liquid metal and that is adjacent to an upstream plane and parts of the first, second, third and fourth distal end portions are adapted to abut against first and second face walls of the mold housing.

38. The method of claim 33, wherein the first, second, third and fourth side walls have first, second, third and fourth distal end portions, wherein the first distal end portion has a first facing end portion extending inwardly or outwardly from the first distal end portion, wherein the second distal end portion has a second facing end portion extending inwardly or outwardly from the second distal end portion, wherein the third distal end portion has a third facing end portion extending inwardly or outwardly from the third distal end portion, wherein the fourth distal end portion has a fourth facing end portion extending inwardly or outwardly from the fourth distal end portion, and wherein, in use, parts of the first, second, third and fourth facing end portions are adapted to contact and abut against the first and second face walls of the mold housing.

39. The method of claim 33, wherein the filter extends along a longitudinal axis residing within an imaginary longitudinal plane that bisects the filter in two halves, wherein the top wall comprises a first portion and a second portion connected to the first portion, the second portion extending transversely with respect to the longitudinal axis and being located downwards the first portion along the longitudinal axis.

40. The method of claim 39, wherein the first portion is defined by first, second, third and fourth trapezium surfaces and the second portion is a square or rectangular surface.

41. The method of claim 39, wherein the second portion is centrally located with respect to the longitudinal axis.

42. The method of claim 39, wherein the longitudinal axis is a first axis and the filter extends along a second axis that is parallel to the first axis, the second portion being centrally located with respect to the second longitudinal axis.

43. The method of claim 39, wherein the first, second, third and fourth side walls have first, second, third and fourth distal end portions, wherein the first distal end portion has a first facing end portion extending inwardly or outwardly from the first distal end portion, wherein the second distal end portion has a second facing end portion extending inwardly or outwardly from the second distal end portion, wherein the third distal end portion has a third facing end portion extending inwardly or outwardly from the third distal end portion, wherein the fourth distal end portion has a fourth facing end portion extending inwardly or outwardly from the fourth distal end portion, and wherein, in use, parts of the first, second, third and fourth facing end portions are adapted to contact and abut against the first and second face walls of the mold housing.

44. The method of claim 33, wherein each of the first, second, third and fourth side walls extends downwardly and outwardly from the top wall and wherein the filter has a frustopyramidal shape.

45. The method of claim 40, wherein the longitudinal axis is a first axis and the filter extends along a second axis that is parallel to the first axis, the second portion being centrally located with respect to the second longitudinal axis.

46. The method of claim 40, wherein the first and second portions define an internal protuberance for handling the filter with a tool or gripping device.

47. A process for manufacturing a filter for use in filtering liquid metal prior to entry into a mold, the process comprising:
providing a fabric comprising glass fibers;
impregnating the fabric with an impregnation composition comprising polymerized saccharide units and an inorganic colloidal binding agent to obtain an impregnated fabric;
heating the impregnated fabric to induce the impregnation composition into a softened thermoplastic state to produce a thermosettable fabric;
providing at least a portion of the thermosettable fabric as a flat thermosettable fabric sheet;
molding the flat thermosettable fabric sheet to form a molded fabric component having four side walls extending from a top wall and being joined at four corners, wherein the molding is performed such that reinforcement is provided at the corners; and
subjecting the molded fabric component to a thermosetting treatment to produce the filter composed of rigidified molded fabric.

48. A method of casting a metal object, comprising:
supplying a liquid metal toward a mold; and
filtering the liquid metal prior to entry into the mold to produce a filtered liquid metal;
wherein the filter is manufactured comprising the steps of:
providing a fabric comprising glass fibers;
impregnating the fabric with an impregnation composition comprising polymerized saccharide units and an inorganic colloidal binding agent to obtain an impregnated fabric;
heating the impregnated fabric to induce the impregnation composition into a softened thermoplastic state to produce a thermosettable fabric;
providing at least a portion of the thermosettable fabric as a flat thermosettable fabric sheet;
molding the flat thermosettable fabric sheet to form a molded fabric component having four side walls extending from a top wall and being joined at four corners, wherein the molding is performed such that reinforcement is provided at the corners; and
subjecting the molded fabric component to a thermosetting treatment to produce the filter composed of rigidified molded fabric; and
supplying the filtered liquid metal into the mold.
